(19) United States
(12) Patent Application Publication
(10) Pub. No.: US 2016/0074938 A1
(43) Pub. Date: Mar. 17, 2016

(54) PRODUCTION METHOD FOR THREE-DIMENSIONAL SHAPED ARTICLE

(71) Applicant: SHIMABUN CORPORATION, Kobe-shi (JP)

(72) Inventors: Kensuke KITANI, Kobe-shi (JP); Motofumi YAMAJI, Kobe-shi (JP)

(73) Assignee: SHIMABUN CORPORATION

(21) Appl. No.: 14/950,103

(22) Filed: Nov. 24, 2015

Related U.S. Application Data
(63) Continuation-in-part of application No. PCT/JP2014/058604, filed on Mar. 26, 2014.

(30) Foreign Application Priority Data
May 24, 2013 (JP) 2013-110002

(51) Int. Cl. B22F 3/105; B23K 13/01; B23K 37/00; B23K 26/342

(52) U.S. Cl. CPC B22F 3/1055; B23K 26/342; B23K 13/01; B23K 37/00; B22F 2003/1053; B23K 2203/18

(57) ABSTRACT

One embodiment of the present invention is a production method for a three-dimensional shaped article, the method comprising the following: a mixing step for obtaining a dissimilar metal mixed powder by mixing a first metal powder (P1) and a second metal powder (P2) different from the first metal powder (P1); and a shaping step for sintering, or melting and solidifying, the dissimilar metal mixed powder obtained in the mixing step. Based on the part of the three-dimensional shaped article to be produced, the mixing ratio of the first metal powder (P1) and the second metal powder (P2) is changed in the mixing step.

### CROSS-REFERENCE TO RELATED APPLICATIONS

This application is a continuation-in-part of PCT application number PCT/JP2014/058604 filed Mar. 26, 2014, the contents of which are incorporated herein by reference. That application was based on and claims priority to Japanese patent application number 2013-110002 filed May 24, 2013, the contents of which are also incorporated herein by reference.

### TECHNICAL FIELD

The present invention relates to a production method for three-dimensional shaped article made of a metal powder.

### BACKGROUND ART

As a production method for three-dimensional shaped article made of a metal powder, there are methods described in PTL 1 and PTL 2 for example. PTL 1 and PTL 2 each describes a production method in which laser beams are selectively applied to thin layers of a metal powder material to sinter or melt and solidify the thin layers, and repeatedly forming those thin layers sintered or molten and solidified to form a three-dimensional shaped article.

This production method facilitates formation of a three-dimensional shaped article having a complex shape, as compared with methods such as rolling, forging, and cutting. The method is further advantageous in terms of the yield. For the above reasons, the production method is particularly suitable for production of various types of metal products in small quantities.

### CITATION LISTING

### Patent Literature

[PTL 1] Japanese Unexamined Patent Publication No. 2011-21218

[PTL 2] Japanese Unexamined Patent Publication No. 2008-81840

### DISCLOSURE OF THE INVENTION

### Technical Problem

With the above production methods described in PTL 1 and PTL 2 however, a produced three-dimensional shaped article made of metal powder has the same properties (physical, chemical properties) throughout the entire article. This is because the three-dimensional shaped article is produced by repeatedly layering a single type of metal powder or a mixture of two or more types of metal powders.

If properties (physical, chemical properties) of various portions of a single component in a product such as a die for resin molding, an auto part, an engine part for aircraft, an artificial joint are differentiated according to the properties required for the portions, it is possible to produce a component (product) with a significantly high added value. This, in other words, means for example using an iron material for portions that do not particularly require corrosion resistance for the sake of cost efficiency, and using a titanium material for portions that require the both strength and corrosion resistance.

In view of the above, the present invention is made and it is an object of the present invention to provide a production method for a three-dimensional shaped article made of a metal powder, which method is capable of producing a component (product) with portions having different properties (physical, chemical properties).

A second object of the present invention to provide a production method for a three-dimensional shaped article made of a metal powder, having a step in which metal powder or a molten metal powder is easily layered.

### Technical Solution

An aspect of the present invention is a production method for three-dimensional shaped article, including: a mixing step of mixing a first metal powder and a second metal powder different from the first metal powder, to obtain a dissimilar metal mixed powder; and a shaping step of sintering or melting and solidifying the dissimilar metal mixed powder obtained in the mixing step, wherein a mixing ratio of the first metal powder and the second metal powder in the mixing step is varied based on a portion of the three-dimensional shaped article to be produced.

A second aspect of the present invention is a production method for a three-dimensional shaped article, comprising a shaping step of sintering, or melting and solidifying a metal powder, wherein, in the shaping step, the metal powder is fallen on a previously sintered or molten and solidified layer, on a shaping table capable of swinging, the shaping table whose tilt with respect to a horizontal direction is controlled, so as to prevent the metal powder from moving due to the gravity.

It should be noted that, in cases where the metal powder is molten and then layered, the metal powder in the shaping step is molten and then fallen on a previously sintered or molten and solidified layer, on a shaping table capable of swinging, the shaping table whose tilt with respect to a horizontal direction is controlled, so as to prevent the molten metal powder from moving due to the gravity.

### Advantageous Effect

The present invention realizes a production method for a three-dimensional shaped article made of a metal powder, which method is capable of producing a component (product) with portions having different properties (physical, chemical properties).

Further, with the second aspect of the present invention, the metal powder (or the molten metal powder) fallen on the shaping table is easily supported on the previously sintered or molten and solidified layer. This facilitates layering of the metal powder (or the molten metal powder). As the result, production of a three-dimensional shaped article having a complex shape is made easy.

### BRIEF DESCRIPTION OF THE DRAWINGS

FIG. 1 is a diagram showing an example three-dimensional shaped article made of a metal powder, whose portions have different properties (physical, chemical properties).

FIG. 2A shows a production facility for explaining a production method relative to a first embodiment according to the present invention, for a three-dimensional shaped article.

FIG. 2B is a diagram of the intermediate bed shown in FIG. 2A, viewed from the above.

FIG. 3 shows a production facility for explaining a production method relative to a second embodiment according to the present invention, for a three-dimensional shaped article.

FIG. 4 shows a production facility for explaining a production method relative to a third embodiment according to the present invention, for a three-dimensional shaped article.

### DESCRIPTION OF EMBODIMENTS

The following describes embodiments of the present invention, with reference to the attached drawings.

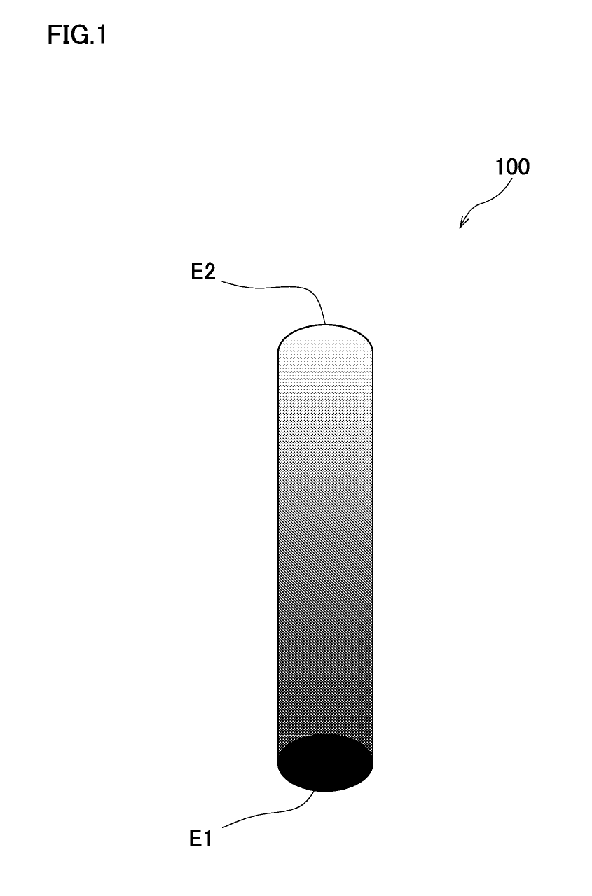

First, with reference to FIG. 1, the following describes a three-dimensional shaped article (shaped article having a three-dimensional shape, hereinafter simply referred to as shaped article) which is obtainable by the production method of the present invention. For example, a cylindrical shaped article 100 is a shaped article having a three-dimensional shape, which is made of an iron powder and a titanium powder. Its one end portion E1 is made of 100% iron, and the other end portion E2 is made of 100% titanium. A portion between the one end portion E1 and the other end portion E2 is formed by sintering or melting and solidifying a dissimilar metal mixed powder containing the iron powder and a titanium powder at a predetermined ratio. The ratio of the titanium is gradually increased from the one end portion E1 towards the other end portion E2.

It should be noted that, with the production method of the present invention, it is easy to form a shaped article having a complex shape according to the use (the cylindrical shaped article 100 shown in FIG. 1 is no more than an example shaped article obtainable by the production method of the present invention). Further, the properties of portions of the shaped article are not limited to those which gradually changes from the one end portion E1 side to the other end portion E2 side as shown in FIG. 1, and may be adjusted according to the properties required for each portion. Further, the production method of the present invention is also adoptable for production of a shaped article (three-dimensional shaped article) only using a single kind of metal powder, such as a shaped article using an iron powder only, or a shaped article using a titanium powder only.

### First Embodiment

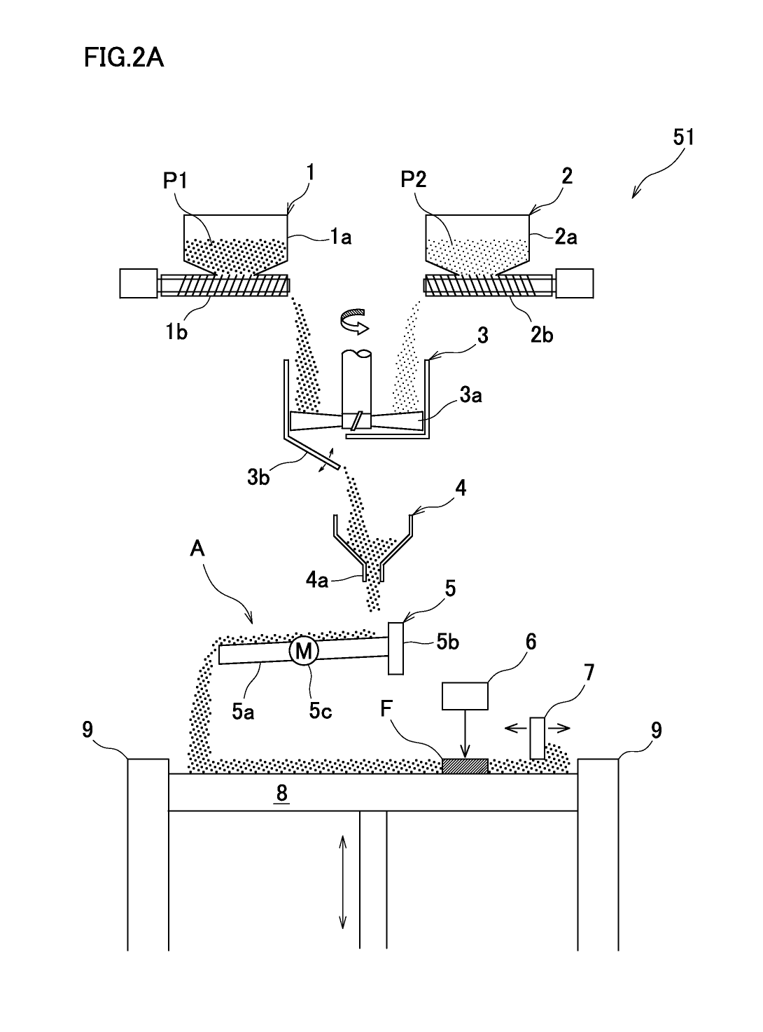

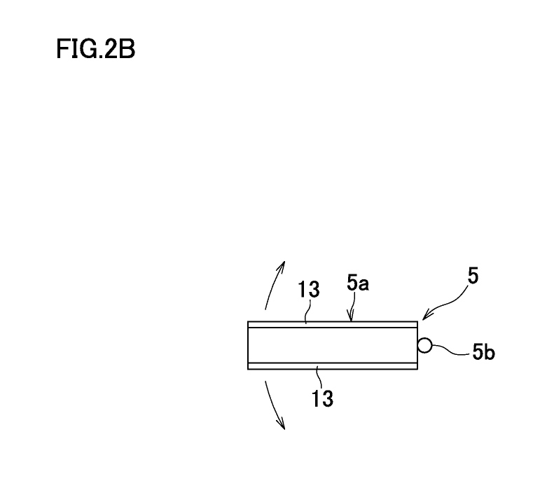

A first embodiment of the production method according to the present invention, for a three-dimensional shaped article is described below, with reference to FIGS. 2A and 2B. A production facility 51 includes sequentially from the upstream side of the process, a first screw feeder 1 and a second screw feeder 2; a material mixer 3; a hopper 4 (container); an intermediate bed 5; and a shaping table 8 having a laser beam emitting unit 6 and the like.

The production method of the disclosure for a three-dimensional shaped article includes: a mixing step of obtaining a dissimilar metal mixed powder; and a shaping step of sintering or melting and solidifying the dissimilar metal mixed powder obtained in the mixing step, wherein a mixing ratio of the metal powders in the mixing step is varied based on the portion of the shaped article to be produced. This way, each portion of the product exhibits required properties (physical, chemical properties). This is detailed below. Examples of the metal powder used as a material in the production method include powders of: iron, titanium, a titanium alloy, stainless steel, aluminum, an aluminium alloy, copper, nickel, and a nickel alloy. Note that other various metal powders are also adoptable as the material. The grain diameter of the powder is for example from φ10 to 50 μm.

### <Mixing Step>

The mixing step is a step of obtaining a dissimilar metal mixed powder, by mixing a first metal powder P1 and a second metal powder P2 different from the first metal powder P1. The screw feeders 1 and 2 have containers 1a and 2a for storing metal powders P1 and P2, and screw type feeders 1b and 2b disposed below the containers 1a and 2a, which are configured to feed predetermined amounts of the metal powders P1 and P2, respectively.

The first metal powder P1 falls from the first screw feeder to the material mixer 3, and is supplied to the material mixer 3. Similarly, the second metal powder P2 falls from the second screw feeder to the material mixer 3, and is supplied to the material mixer 3. The metal powders P1 and P2 fallen and supplied to the material mixer 3 are agitated and mixed in the material mixer 3 by an agitator 3a, until the powders are evenly mixed.

It should be noted that the screw feeders 1 and 2 are temporarily stopped when the supply of predetermined amounts of metal powders P1 and P2 to the material mixer 3 is completed. The entire dissimilar metal mixed powder in which the first metal powder P1 and the second metal powder P2 are evenly mixed falls from the material mixer 3 into the hopper 4. When the material mixer 3 is emptied, operations of the screw feeders 1 and 2 are resumed for the purpose of supplying next loads of metal powders P1 and P2 into the material mixer 3.

It should be noted that, where the mixing ratio of the 1 metal powder P1 and the second metal powder P2 is 1:2, for example, the metal powders P1 and P2 are supplied from the screw feeders 1 and 2 to the material mixer 3 at the ratio of 1:2, respectively. Further, when a portion of 100% first metal powder P1 is to be shaped, only the first metal powder P1 is supplied from the first screw feeder 1 to the material mixer 3, while second screw feeder 2 is stopped.

### <Shaping Step>

The shaping step is a step of sintering or melting and solidifying the dissimilar metal mixed powder obtained in the mixing step. The dissimilar metal mixed powder in which the first metal powder P1 and the second metal powder P2 are evenly mixed is supplied into the hopper 4 by rotating and opening a bottom plate 3b of the material mixer 3.

For example, to the hopper 4 is supplied the dissimilar metal mixed powder for approximately 1 layer of the shaped article to be produced. Note that, by stopping a motor 5c for example, the intermediate bed 5 is able to temporarily retain the dissimilar metal mixed powder. Therefore, the dissimilar metal mixed powder for 2 layers may be supplied at once to the hopper 4.

The hopper 4 is, for example, a container having a counter conical shape, and its outlet port 4a at the bottom has a diameter smaller (the aperture is smaller) than the opening portion (metal powder receiving portion) at the top of the hopper 4. The dissimilar metal mixed powder supplied to the hopper 4 falls from this outlet port 4a having a smaller diameter on to the intermediate bed 5.

The intermediate bed 5 includes a bed body 5a (vibration conveyor part) to which the motor 5c is attached, and a supporting shaft 5b serving as an axis for rotating the bed body 5a in a horizontal direction. The bed body 5a is declined towards its leading end with respect to a horizontal direction, and is configured to vibrate with drive of the motor 5c. This way, the dissimilar metal mixed powder having fallen to the bed body 5a falls on to the shaping table 8 from the end portion (leading end portion) on the opposite side to the supporting shaft 5b. The end portion (leading end portion) of the bed body 5a on the opposite side to the supporting shaft 5b is configured to rotate in a horizontal direction. Therefore, it is possible to avoid the metal powders piling up in a single position on the top surface of the shaping table 8. The bed body 5a has on its both side portions a guide wall part 13 extended in the direction of feeding the dissimilar metal mixed powder (see FIG. 2B), and is configured to prevent the dissimilar metal mixed powder from falling on to the shaping table 8 over the both end portions. FIG. 2B is a diagram of the intermediate bed 5 shown in FIG. 2A, viewed from the above.

It should be noted that the present embodiment deals with a case where the intermediate bed 5 is a vibrating conveyor type; however, it is possible to adopt an intermediate bed of a belt-conveyor type. In some cases, a belt-conveyor type is preferable so that the metal powders are not separated from one another due to their specific gravities and grain diameters.

Around the shaping table 8 is a table guide wall 9 which is arranged to surround the shaping table 8. The shaping table 8 and the table guide wall 9 contact with each other and are capable of sliding with respect to each other. The table guide wall 9 is fixed. On the other hand, the shaping table 8 is configured to be moveable in the vertical directions (upward/downward directions) (the shaping table 8 is moveable in the vertical directions (up/down directions) by means of a non-illustrated actuator).

The dissimilar metal mixed powder having fallen on to the shaping table 8 is evened out and forms a thin layer, by a blade 7 moving in a horizontal direction. It should be noted that the thickness of each thin layer is determined by the amount of the table guide wall 9 protruding from the top surface of the shaping table 8.

The thin layer made of the dissimilar metal mixed powder on the shaping table 8 is selectively sintered or molten and solidified by a laser beam from the laser beam emitting unit 6 which is controlled by a not-illustrated controller. The laser beam emitting unit 6 is controlled by the not-shown controller based on slice data (draw pattern) of a shaped article to be produced.

Subsequently, the shaping table 8 is descended by an amount of one thin layer, and the dissimilar metal mixed powder is fallen on to the shaping table 8 again. The dissimilar metal mixed powder is then evened out by the blade 7 to form another thin layer. The thin layer is then sintered or molten and solidified by a laser beam from the laser beam emitting unit 6, based on the slice data (draw pattern) of the shaped article to be produced. A desirable shaped article is formed by repeating the formation of a thin layer and application of a laser beam.

It should be noted that the metal powder is preferably sintered or molten and solidified under a reduced-pressure atmosphere (encompassing a vacuum condition), or under an inert gas atmosphere such as an argon gas atmosphere (the same applies to the later-described second and third embodiments).

### <Changes in Mixing Ratio of Metal Powders>

In the present invention, the mixing ratio of the first metal powder P1 and the second metal powder P2 is changed in the mixing step, based on the portion of the shaped article to be produced. For example, suppose that the first metal powder P1 is an iron powder and the second metal powder P2 is a titanium powder. For a portion of the shaped article which does not particularly require corrosion resistance, the percentage of the first metal powder P1 is increased for the sake of cost efficiency. For a portion that requires the both strength and corrosion resistance, the percentage of the second metal powder P2 is increased. The percentage of the first metal powder P1 may be made 100%, or the percentage of the second metal powder P2 may be made 100%.

Based on the properties (physical, chemical properties) of the part of the three-dimensional shaped article to be produced, the mixing ratio of the first metal powder P1 and the second metal powder P2 is determined. Further, the total quantity of the metal powders P1 and P2 is determined based on the range (volume) of the portion. By agitating and mixing the above-determined quantities of metal powders P1 and P2 at the above-determined mixing ratio in the material mixer 3, the dissimilar metal mixed powder to be used in the subsequent shaping step is obtained.

### (Actions and Effects)

The present invention allows production of a shaped article which is a component (product) whose portions have different properties (physical, chemical properties), by changing the mixing ratio of the first metal powder P1 and the second metal powder P2 in the mixing step, based on the portion of the shaped article to be produced. With this, it is possible to produce a component (product) with a high added value.

In the present embodiment, in the mixing step, the first metal powder P1 and the second metal powder P2 are fallen into the material mixer 3 from thereabove, and are agitated and mixed in the material mixer 3.

As hereinabove mentioned, it is necessary to change the mixing ratio of the first metal powder P1 and the second metal powder P2 in the mixing step, based on the portion of the shaped article to be produced, and spread the evenly mixed dissimilar metal mixed powder on the shaping table 8.

With the structure in which the first metal powder P1 and the second metal powder P2 are fallen into the material mixer 3 from thereabove, the step of changing the mixing ratio of the first metal powder P1 and the second metal powder P2, and the step of spreading the evenly mixed dissimilar metal mixed powder on the shaping table 8 are carried out as a series of steps with less time lags. This improves the productivity of a shaped article as a single component (product) whose portions have different properties (physical, chemical properties).

Further, the present embodiment deals with a case where, in the shaping step, the dissimilar metal mixed powder is fallen from the material mixer 3 on to the shaping table 8, via the hopper 4 (container) having the outlet port 4a with a reduced diameter. With this structure, the position where the dissimilar metal mixed powder falls is limited to a desirable position. It is therefore possible to prevent the dissimilar metal mixed powder from being unnecessarily scattered.

Further, the present embodiment deals with a case where, in the shaping step, the dissimilar metal mixed powder is fallen from the hopper 4 on to the shaping table 8 via the intermediate bed 5 which is capable of rotating in a horizontal direction, and then the dissimilar metal mixed powder is formed into a thin layer by the blade 7. With this structure, the intermediate bed 5 capable of rotating in a horizontal direction improves the performance of spreading the dissimilar metal mixed powder on the shaping table 8. That is, while preventing unnecessary scattering of the dissimilar metal mixed powder, the performance of spreading the dissimilar metal mixed powder on the shaping table 8 is improved.

### Second Embodiment

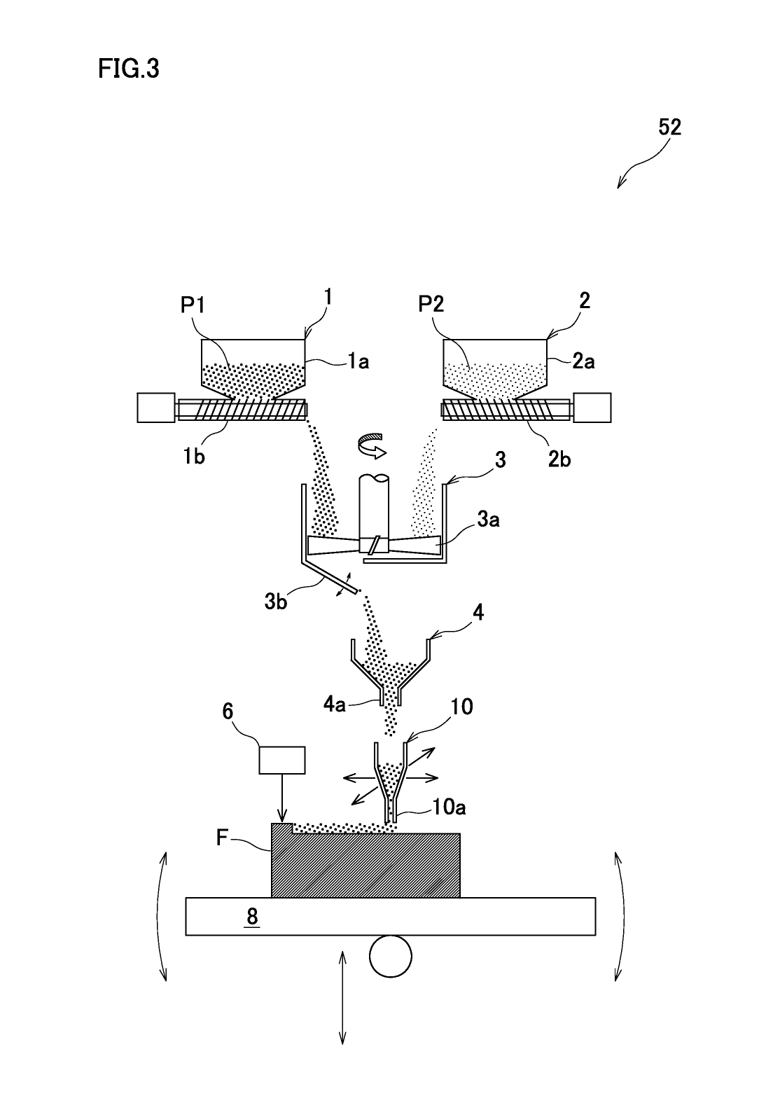

A second embodiment of the production method according to the present invention, for a three-dimensional shaped article is described below, with reference to FIG. 3. It should be noted that in the following description, structural elements that are identical to those of the production facility 51 described in first Embodiment are given the same reference numerals, and the overlapping descriptions will be omitted as needed (the same applies to third Embodiment).

The second Embodiment differs from the first Embodiment in that a production facility 52 of the second Embodiment includes a position-controllable powder supply container 10 between the hopper 4 and the shaping table 8, and that the shaping table 8 is capable of sliding in vertical directions (upward/downward directions) and swing relative to the vertical directions (upward/downward directions). The metal powder is fallen on to the previously sintered or molten and solidified layer on the shaping table 8, via the position-controllable powder supply container 10. The shaping table 8 is capable of swinging, whose tilt with respect to a horizontal direction is controlled so as to prevent the fallen metal powder from moving due to the gravity.

The powder supply container 10 is, for example, a feeder having a slender counter conical shape, and its ejection port 10a at the bottom has a diameter smaller (the aperture is smaller) than the outlet port 4a of the hopper 4. The dissimilar metal mixed powder supplied to the powder supply container 10 falls from this ejection port 10a having a reduced diameter on to the shaping table 8 (spread on the shaping table 8).

The position of the ejection port 10a of the powder supply container 10 (powder supply container 10) is controlled by the not-shown controller based on slice data (draw pattern) of a shaped article to be produced. In other words, the dissimilar metal mixed powder is fallen from the powder supply container 10, only on to a position of the shaped article to be produced (a position or coordinates targeted for sintering or melting and solidifying) on the shaping table 8 (or on a previously sintered or molten and solidified layer). It should be noted that, although the above description mentions a position of the shaped article to be produced, the dissimilar metal mixed powder is fallen in a range of that position and some extra space therearound.

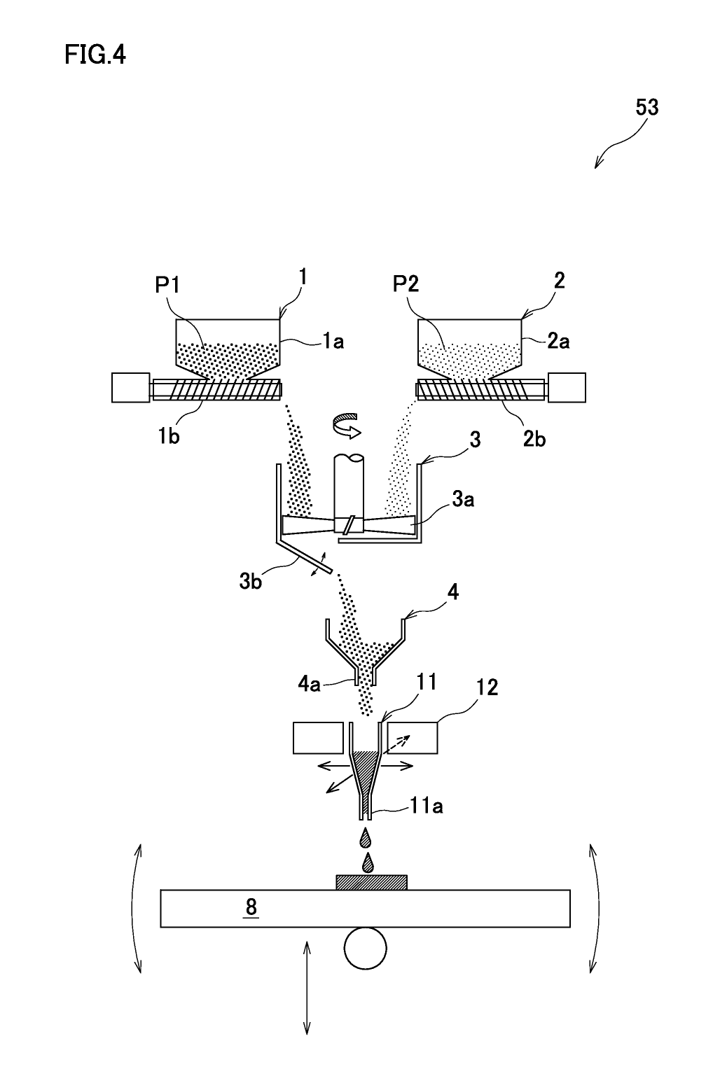

It should be noted that the present embodiment deals with an example case involving the powder supply container 10 capable of moving only in horizontal directions (as indicated by the arrow placed in the powder supply container 10 shown in FIG. 3), the powder supply container may be configured to move in horizontal directions as well as in vertical directions (upward/downward directions) (the same applies to a molten metal supply container 11 shown in FIG. 4).

It should be noted that, in cases where the powder supply container 10 receives the dissimilar metal mixed powder from the hopper 4, the powder supply container 10 is moved to a position below the hopper 4.

Further, in the present embodiment, the shaping table 8 is capable of sliding in the vertical directions (upward/downward directions) and is capable of swinging in the vertical directions (upward/downward directions) (i.e., the tilt with respect to a horizontal direction is controllable). When the dissimilar metal mixed powder is to be spread only in a position on a previously sintered or molten and solidified layer of the shaped article to be produced (in a previously sintered or molten and solidified position), the dissimilar metal mixed powder having been spread may move (fall) due to the gravity from the position it is spread depending on the shape of the shaped article to be produced. To prevent the spread dissimilar metal mixed powder from moving due to the gravity, i.e., to support the spread dissimilar metal mixed powder on a previously sintered or molten and solidified layer, the not-shown controller controls the tilt of the shaping table 8 relative to the horizontal direction in the present embodiment.

### (Actions and Effects)

The present embodiment deals with a case where, in the shaping step, the dissimilar metal mixed powder is fallen from the hopper 4 on to the shaping table 8, via the position-controllable powder supply container 10 having the ejection port 10a with a diameter smaller than that of the outlet port 4a of the hopper 4. More specifically, at the very beginning of the production process, the dissimilar metal mixed powder is directly fallen on to the shaping table 8, and then the dissimilar metal mixed powder is fallen on to a previously sintered or molten and solidified layer.

This structure promises an improved yield of metal powders, because a shaped article is produced without formation of a thin layer of metal powder on the entire shaping table 8. Further, while the first Embodiment necessitates a step of sorting the non-sintered, molten, or solidified metal powders P1 and P2 into the first metal powder P1 and the second metal powder P2, and then return them to the screw feeders 1 and 2, respectively, the second Embodiment minimizes the quantities of the metal powders P1 and P2 to be returned to the screw feeders 1 and 2.

By having the metal powder fallen on the previously sintered or molten and solidified layer on the shaping table 8, while controlling the tilt of the shaping table 8 with respect to a horizontal direction so that the metal powder does not move due to the gravity, it is possible to prevent the metal powder having been spread from moving (falling) due to the gravity. With the method of having the metal powder fallen, in production of a three-dimensional shaped article, the metal powder having fallen is easily supported on the previously sintered or molten and solidified layer. This facilitates layering of the metal powder. As the result, production of a three-dimensional shaped article having a complex shape is made easy.

### Third Embodiment

A third Embodiment of the production method according to the present invention for a three-dimensional shaped article is described below, with reference to FIG. 4.

The difference between the second Embodiment and the third Embodiment is as follows. Namely, while the second Embodiment employs a position-controllable powder supply container 10, a production facility 53 of the third Embodiment employs a position-controllable molten metal supply container 11. The molten metal powder is fallen on to the previously sintered or molten and solidified layer on the shaping table 8, via the position-controllable molten metal supply container 11. The shaping table 8 is capable of swinging, whose tilt with respect to a horizontal direction is controlled so as to prevent the molten metal from moving due to the gravity.

The molten metal supply container 11 is, for example, a feeder having a slender counter conical shape, and its ejection port 11a at the bottom has a diameter smaller (the aperture is smaller) than the outlet port 4a of the hopper 4. For example, around the upper portion of the molten metal supply container 11 is attached an induction heater 12. The induction heater 12 is for melting the metal powders P1 and P2. The aperture of the ejection port 11a is such that the molten metal of the metal powders P1 and P2 drips in a very small quantity at a time. The dissimilar metal mixed powder supplied to the molten metal supply container 11 is molten therein, and dripped in a very small quantity at a time from its ejection port 11a having a reduced diameter on to the shaping table 8. It should be noted that the method of melting the metal powders is not limited to an induction heating method.

Similarly to the powder supply container 10 of the second Ejection port, the position of the ejection port 11a of the molten metal supply container 11 (molten metal supply container 11) is controlled by the not-shown controller based on slice data (draw pattern) of a shaped article to be produced. In other words, the dissimilar metal mixed powder is dripped from the molten metal supply container 11, only on to a position of the shaped article to be produced (a position or coordinates targeted for sintering or melting and solidifying) on the shaping table 8 (or on a previously sintered or molten and solidified layer).

It should be noted that, in cases where the molten metal supply container 11 receives the dissimilar metal mixed powder from the hopper 4, the molten metal supply container 11 is moved to a position below the hopper 4.

Further, as in the case of the second Embodiment, in the present embodiment, the shaping table 8 is capable of sliding in the vertical directions (upward/downward directions) and is capable of swinging in the vertical directions (upward/downward directions). When the molten metal is to be dripped only in a position on a previously-solidified layer of the shaped article to be produced (in the position to be solidified), the molten metal dripped may move (fall) due to the gravity from the position it is dripped depending on the shape of the shaped article to be produced. To prevent the molten metal from moving due to the gravity, i.e., to support the molten metal on the previously-solidified layer, the not-shown controller controls the tilt of the shaping table 8 relative to the horizontal direction in the present embodiment.

### (Actions and Effects)

The present embodiment deals with a case where, in the shaping step, the dissimilar metal mixed powder is molten in the position-controllable molten metal supply container 11 having the ejection port 11a with a diameter smaller than that of the outlet port 4a of the hopper 4, and then the molten metal is dripped on to the shaping table 8. More specifically, at the very beginning of the production process, the molten metal is directly fallen on to the shaping table 8, and then the molten metal is fallen on to the last-solidified layer.

Similarly to the second Embodiment, this structure promises an improved yield of metal powders, because a shaped article is produced without formation of a thin layer of metal powder on the entire shaping table 8. Further, while the first Embodiment necessitates a step of sorting the non-sintered, molten, or solidified metal powders P1 and P2 into the first metal powder P1 and the second metal powder P2, and the return them to the screw feeders 1 and 2, respectively, the third Embodiment does not require the work of returning the quantities of the metal powders P1 and P2 to the screw feeders 1 and 2.

By having the metal powder molten and then fallen (dripped) on the previously sintered or molten and solidified layer on the shaping table 8, while controlling the tilt of the shaping table 8 with respect to a horizontal direction so that the molten metal (molten metal powder) fallen (dripped) does not move due to the gravity, it is possible to prevent the metal powder having been spread from moving (falling) due to the gravity. With the method of having the molten metal powder fallen on the previously sintered or molten and solidified layer, in production of a three-dimensional shaped article, the molten metal having fallen (dripped) is easily supported on the previously sintered or molten and solidified layer. This facilitates layering of the molten metal. As the result, production of a three-dimensional shaped article having a complex shape is made easy.

While illustrative and presently preferred embodiments of the present invention have been described in detail herein, it is to be understood that the inventive concepts may be otherwise variously embodied and employed within the scope of the appended claims.

For example, the hopper 4 (container) may be omitted in the structures shown in FIGS. 2A, 3, and 4.

For example, while the above embodiments each deal with a case of involving two different types of metal powders as the material for producing the shaped article, it is possible to adopt three or more different types of metal powders as the material for producing a shaped article. In other words, the application of the present invention is not limited to production of shaped articles using only two different types of metal powders, and is applicable to cases of producing shaped articles with three or more different types of metal powders. To use three or more different types of metal powders, for example, three screw feeders are provided for storing and feeding the metal powders. The different types of metal powders are put in the screw feeders, respectively, and the metal powders are supplied from the three screw feeders into the material mixer to mix the three different types of metal powders in the material mixer.

Further, it is possible to produce a shaped article using only a single kind of metal powder. In cases of using only a single kind of metal powder, only one screw feeder is needed for storing and feeding the metal powder, and the material mixer 3 is not necessary.

### LISTING OF REFERENCE NUMERALS

1: First Screw Feeder
2: Second Screw Feeder
3: Material Mixer
4: Hopper (Container)
5: Intermediate Bed
6: Laser Beam Emitting Unit
7: Blade
8: Shaping Table
9: Table Guide Wall
P1: First Metal Powder
P2: Second Metal Powder

1. A production method for a three-dimensional shaped article, comprising a shaping step of sintering, or melting and solidifying a metal powder, wherein,
in the shaping step, the metal powder is fallen from the container on to a previously sintered or molten and solidified layer on the shaping table, via a position-controllable powder supply container having an ejection port with a smaller diameter than that of an outlet port of the container.

2. The method according to claim 1, wherein
in the shaping step, the metal powder is fallen on to the previously sintered or molten and solidified layer on the shaping table, via a position-controllable powder supply container.

3. The method according to claim 2, wherein
in the shaping step, the metal powder is fallen from the container on to a previously sintered or molten and solidified layer on the shaping table, via the position-controllable powder supply container having an ejection port with a smaller diameter than that of a diameter-reduced outlet port of the container.

4. A production method for a three-dimensional shaped article, comprising a shaping step of sintering, or melting and solidifying a metal powder, wherein,
in the shaping step, the metal powder is molten and then fallen on a previously sintered or molten and solidified layer, on a shaping table capable of swinging, the shaping table whose tilt with respect to a horizontal direction is controlled, so as to prevent the molten metal powder from moving due to the gravity.

5. The method according to claim 4, wherein
in the shaping step, the metal powder is molten and then fallen on to the previously sintered or molten and solidified layer on the shaping table, via a position-controllable molten metal supply container.

6. The method according to claim 5, wherein
in the shaping step, the metal powder is molten and then fallen from the container on to a previously sintered or molten and solidified layer on the shaping table, via the position-controllable molten metal supply container having an ejection port with a smaller diameter than that of a diameter-reduced outlet port of the container.

7. A production method for a three-dimensional shaped article, comprising a shaping step of sintering, or melting and solidifying a metal powder, wherein,
in the shaping step, the metal powder is fallen on to an intermediate bed capable of rotating in a horizontal direction, and then the metal powder is fallen from the intermediate bed on to a shaping table and formed into a thin layer with a use of a blade,
wherein the intermediate bed includes
a bed body to which a motor is attached, which is declined towards its leading end with respect to a horizontal direction, and
in the shaping step, the bed body is vibrated with drive of the motor, thereby causing the metal powder on to the shaping table.

8. The method according to claim 7, wherein
in the shaping step, the metal powder is fallen on to the intermediate bed capable of rotating in a horizontal direction via a container having a diameter-reduced outlet port, and then the metal powder is fallen from the intermediate bed on to the shaping table and formed into a thin layer with a use of the blade,
wherein the bed body has a guide wall part on its both sides relative to a direction in which the metal powder moves.

9. The method according to claim 1, wherein
the metal powder is a dissimilar metal mixed powder obtained through a mixing step of mixing a first metal powder and a second metal powder different from the first metal powder, and
wherein a mixing ratio of the first metal powder and the second metal powder in the mixing step is varied based on a portion of the three-dimensional shaped article to be produced.

10. The method according to claim 9, wherein
in the mixing step, the first metal powder and the second metal powder are fallen into a material mixer from thereabove, and are agitated and mixed in the material mixer.

11. The method according to claim 4, wherein
the metal powder is a dissimilar metal mixed powder obtained through a mixing step of mixing a first metal powder and a second metal powder different from the first metal powder, and
wherein a mixing ratio of the first metal powder and the second metal powder in the mixing step is varied based on a portion of the three-dimensional shaped article to be produced.

12. The method according to claim 11, wherein
in the mixing step, the first metal powder and the second metal powder are fallen into a material mixer from thereabove, and are agitated and mixed in the material mixer.

13. The method according to claim 7, wherein
the metal powder is a dissimilar metal mixed powder obtained through a mixing step of mixing a first metal powder and a second metal powder different from the first metal powder, and
wherein a mixing ratio of the first metal powder and the second metal powder in the mixing step is varied based on a portion of the three-dimensional shaped article to be produced.

14. The method according to claim 13, wherein
in the mixing step, the first metal powder and the second metal powder are fallen into a material mixer from thereabove, and are agitated and mixed in the material mixer.
